(19) United States
(12) Patent Application Publication
(10) Pub. No.: US 2024/0242219 A1
(43) Pub. Date: Jul. 18, 2024

(54) Dynamic Passive Authentication at Self-Service Kiosk

(71) Applicant: Bank of America Corporation, Charlotte, NC (US)

(72) Inventors: Edward Lee Traywick, Bellbrook, OH (US); Christopher D. Nobile, Charlotte, NC (US); Joshua R. Johnson, Denver, NC (US); Christopher Stephen Littrell, Dallas, TX (US)

(21) Appl. No.: 18/097,739

(22) Filed: Jan. 17, 2023

(51) Int. Cl. G06Q 20/40; G06Q 20/18

(52) U.S. Cl. CPC G06Q 20/40145; G06Q 20/18

(57) ABSTRACT

Arrangements for providing dynamic passive authentication at self-service kiosks are provided. In some aspects, registration data may be received for a plurality of users. The registration data may include biometric data of each user of the plurality of users. In response to receiving an indication of authentication of a user and a request for transaction processing, one or more passive authentication functions may be activated and biometric data may be received from devices associated with the self-service kiosk. The computing platform may compare the received biometric data to registration biometric data associated with the first user. If the received data matches the registration data, the system may capture additional biometric data at a subsequent time. If the received data does not match the registration data, one or more mitigation actions may be identified and executed.

### BACKGROUND

Aspects of the disclosure relate to electrical computers, systems, and devices for passively authenticating users of self-service kiosks, such as automated teller machines (ATMs), automated teller assistants (ATAs), and the like.

Self-service kiosks, and, in some examples, in-person exchanges, often rely on initial data from a user for authentication prior to processing a transaction. For instance, at a self-service kiosk, a user may swipe or scan a card and input a personal identification number (PIN) to initiate a transaction. At an in-person location, the user may present identification, input a username and password, or the like, to initiate and/or process a transaction. However, conventional systems have no way of determining that the person who initiated the transaction is the user who continues through the process. For instance, an unauthorized user at a self-service kiosk may have an authorized user's card and PIN which, in conventional arrangements, would be sufficient to execute a transaction. Accordingly, it would be advantageous to provide arrangements for additional, passive authentication as the user continues to interact with the self-service kiosk to confirm an actual identity of the user and that the authenticated user remains the user processing the transaction.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with authenticating users to ensure unauthorized users are not accessing particular devices or systems.

In some aspects, registration data may be received for a plurality of users. The registration data may include biometric data of each user of the plurality of users. In some arrangements, an indication of authentication of a first user at a self-service kiosk, and a request to process a transaction may be received. In response to receiving the indication of authentication and request to process the transaction, one or more passive authentication functions may be initiated or activated. In some examples, passive authentication may include authenticating a user without requiring or receiving input from the user (e.g., biometric data may be captured as the user interacts with the self-service kiosk and without the user proactively providing the biometric data (e.g., with user permission)).

In some examples, biometric data may be received from one or more biometric data collection devices associated with the self-service kiosk. For instance, a camera, keypad, touch screen, or the like, may capture biometric data and the biometric data may be received by a computing platform. The computing platform may compare the received biometric data to registration biometric data associated with the first user. If the received biometric data matches the registration biometric data of the first user, the system may capture or collect additional biometric data at a subsequent time for analysis.

If the received biometric data does not match the registration biometric data of the first user, one or more mitigation actions may be identified. For instance, mitigation actions such as requesting additional authentication data, initiating capture of additional types of biometric data, locking the first user out of the self-service kiosk, transmitting an authentication request message to a pre-stored user device, modifying functionality of the self-service kiosk, or the like, may be identified. The computing platform may generate an instruction or command causing execution of the one or more mitigation actions and may transmit the instruction or command to the self-service kiosk for execution.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing passive authentication in accordance with one or more aspects described herein;

FIGS. 2A-2E depict an illustrative event sequence for implementing passive authentication in accordance with one or more aspects described herein;

FIG. 3 illustrates an illustrative method for implementing passive authentication according to one or more aspects described herein;

FIGS. 4 and 5 illustrate example user interfaces that may be generated in accordance with one or more aspects described herein; and

FIG. 6 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, conventional systems generally require users to authenticate at initiation of a transaction (e.g., at a self-service kiosk, at an in-person exchange such as a transaction with a banking associate at a branch location, or the like). However, these arrangements in which a user is authenticated only at the start of the requested transaction may enable unauthorized actors to access complete the transaction, or may enable unauthorized users who have obtained an authorized user's card and PIN to conduct transactions.

Accordingly, aspects described herein provide for additional authentication of a user through biometric data captured as the user interacts with the self-service kiosk, one or more user input devices, or the like (e.g., during the normal or expected transaction process). As discussed more fully herein, users may provide biometric data during a registration process. The biometric data may include facial images, retinal scans, fingerprints, and the like. In some examples, registration data may include additional information, such as user permissions, user customization selections, and the like.

Upon receiving an indication that a user has been authenticated to a self-service kiosk and has requested processing of a transaction, passive authentication functions, such as passive biometric authentication processes, may be initiated. In some examples, initiating the passive authentication functions may include retrieving the biometric data of the authenticated user that was received during registration, activating or enabling one or more biometric data capture devices (e.g., camera, keypad with integrated fingerprint scanner, touch screen with integrated fingerprint scanner, or the like).

In some examples, as the user interacts with the self-service kiosk (e.g., selects additional transaction processing options) one or more types of biometric data may be captured and compared to the retrieved biometric data (e.g., registration biometric data). If the data matches, additional biometric data may be captured and compared (e.g., the process may continue to capture and compare biometric data). If the data does not match, one or more mitigation actions may be identified and executed.

As discussed herein, in some examples, the biometric data may be captured and analyzed on a continuous or near-continuous basis. Additionally or alternatively, the biometric data may be captured and analyzed on a periodic or aperiodic basis.

These and various other arrangements will be discussed more fully below.

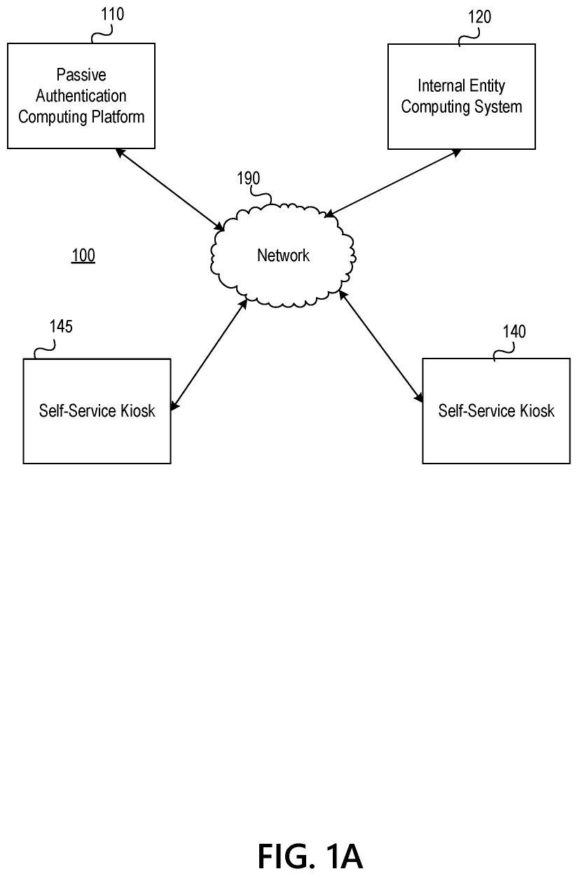

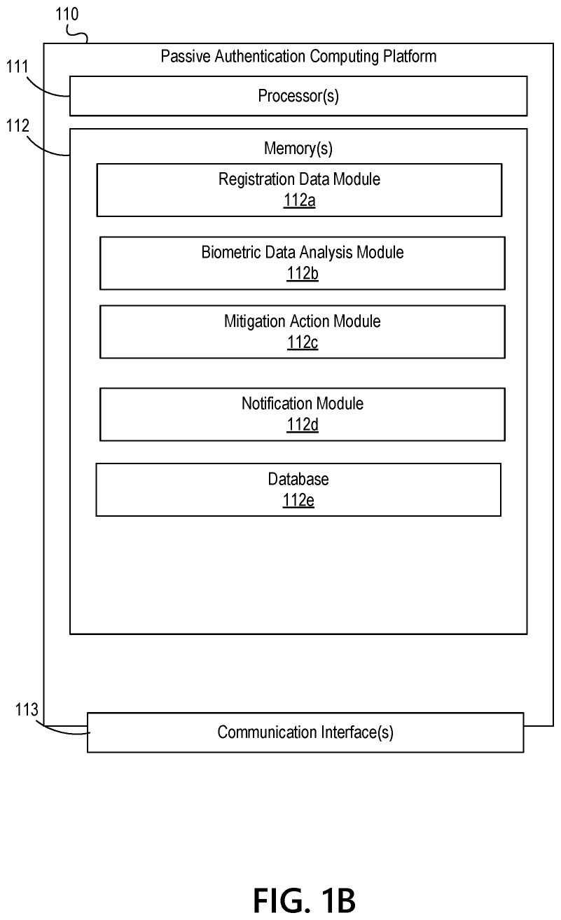

Aspects described herein may be implemented using one or more computing devices operating in a computing environment. For instance, FIGS. 1A-1B depict an illustrative computing environment for implementing passive authentication in accordance with one or more aspects described herein. Referring to FIG. 1A, computing environment 100 may include one or more computing devices and/or other computing systems. For example, computing environment 100 may include passive authentication computing platform 110, internal entity computing system 120, self-service kiosk 140, and/or self-service kiosk 145. Although one internal entity computing system 120 and two self-service kiosks 140, 145 are shown, any number of systems or devices may be used without departing from the invention.

Passive authentication computing platform 110 may be configured to perform intelligent, dynamic, and efficient passive authentication on a continuous, periodic or aperiodic basis. For instance, passive authentication computing platform 110 may receive registration data from a plurality of users (e.g., customers of an enterprise organization, such as a financial institution), and the like. The registration data may be received from the plurality of users with permission of the plurality of users and upon opting in to the passive authentication system, upon opening an account, or the like. The registration data may include biometric data of each registered user (e.g., facial image, retinal scan, fingerprint data, and the like). The registration data may be stored for passive authentication.

Upon requesting a transaction at a self-service kiosk (and, e.g., being authenticated), biometric data of the user may be captured. For instance, a camera or other image capture device associated with the self-service kiosk 140 may capture an image of a face of a user. Additionally or alternatively, a keyboard or keypad associated with the self-service kiosk may include an integrated fingerprint scanner on each key to enable capture of a user's fingerprint with each keystroke. In some examples, the keyboard may include an integrated fingerprint scanner under fewer than all keys (e.g., under numeric keys only, under frequently used keys, under an enter key, or the like). Further, a touch screen input of the self-service kiosk may include an integrated fingerprint scanner. In some examples, an entire touch screen may include the fingerprint scanner such that a user touching any portion of the screen may enable capture of fingerprint data. In other examples, less than all of the touch screen (e.g., between 50% and 90% of the touch screen, or the like) may include the integrated fingerprint scanner and may be configured to capture fingerprint data as the user moved through the process to request and process a transaction.

The captured biometric data may be received by the passive authentication computing platform 110 and compared to the registration data. If the data matches, the user may be considered passively authenticated and additional biometric data may be captured and analyzed at a later time. If the data does not match, one or more mitigation actions may be identified. For instance, an instruction or command requesting additional authentication data from a user, locking a user out of the self-service kiosk, disabling access to one or more functions of the self-service kiosk (e.g., deposits may be permitted but withdrawal functionality may be disabled), or the like may be generated. The generated command or instruction may be transmitted to the impacted self-service kiosk 140. In some examples, transmitting the instruction or command may cause the self-service kiosk 140 to execute the command or instruction, thereby implementing the mitigation action.

In some examples, biometric data of the user may be continuously captured and analyzed as the user interacts with the self-service kiosk 140 during, for instance, the course of the transaction. Additionally or alternatively, biometric data may be captured at periodic intervals (e.g., every minute, every thirty seconds, or the like), at aperiodic intervals, or the like. In some examples, one type of biometric data may be captured continuously or at intervals and, if a match is not detected, additional biometric data or types of biometric data may be captured and analyzed. For instance, a camera may continuously or at intervals capture image data of a user and compare it to registration image data. If the data matches, the camera may continue to capture the image data for analysis. If a match is not detected, the system may initiate capture of fingerprint data from the keyboard or keypad, touch screen or the like, associated with the self-service kiosk 140 (e.g., in addition to the additional image data) to confirm that the user is not authenticated (e.g., avoid or limit false positives).

Internal entity computing system 120 may be or include one or more computing devices (e.g., servers, server blades, or the like) and/or one or more computing components (e.g., memory, processor, and the like) and may be associated with or operated by an enterprise organization implementing the passive authentication computing platform 110. The internal entity computing system 120 may host and/or execute one or more systems, applications, or the like, that may be used to process transactions initiated or performed at a self-service kiosk 140. For instance, internal entity computing system 120 may include one or more systems or applications storing user account data, account ledger data, and the like, and/or may be configured to modify a balance of a user account based on transactions processed by the self-service kiosk 140, and the like. In some examples, if a user is not authenticated via the passive authentication computing platform 110 (e.g., a match between received biometric data and registration biometric data is not detected), a mitigation action modifying access to the systems or applications of the internal entity computing system 120 may be generated and sent to the internal entity computing system 120 for execution (e.g., user account withdrawals may be limited, or the like).

Self-service kiosk 140 and/or self-service kiosk 145 may be or include one or more computing components (e.g., processors, memory, display screen, input keypad or keyboard, touch screen display, and the like), as well as other components (e.g., cash dispensing devices or units, cameras, cash storage units, deposit receiving receptacles, and the like) and may be used by one or more users to process one or more transactions (e.g., deposits, withdrawals, balance transfer, balance inquiry, and the like). One or more components of the self-service kiosk 140 and/or self-service kiosk 145 may include biometric data capture devices. For instance, a camera associated with self-service kiosk 140 and/or self-service kiosk 145 may capture image data of a user requesting a transaction to compare to facial image data provide or captured during the registration process. Additionally or alternatively, keypad or keyboard, touch screen, or the like, of the self-service kiosk 140, 145 may include integrated fingerprint scanners that capture biometric data of a user as the user interacts with the self-service kiosk 140, 145 to request and/or process a transaction.

As mentioned above, computing environment 100 also may include one or more networks, which may interconnect one or more of passive authentication computing platform 110, internal entity computing system 120, self-service kiosk 140 and/or self-service kiosk 145. For example, computing environment 100 may include network 190. In some examples, network 190 may include a private network associated with the enterprise organization. Network 190 may include one or more sub-networks (e.g., Local Area Networks (LANs), Wide Area Networks (WANs), or the like). Network 190 may be associated with a particular organization (e.g., a corporation, financial institution, educational institution, governmental institution, or the like) and may interconnect one or more computing devices associated with the organization. For example, passive authentication computing platform 110, internal entity computing system 120, self-service kiosk 140 and/or self-service kiosk 145 may be associated with an enterprise organization (e.g., a financial institution), and network 190 may be associated with and/or operated by the organization, and may include one or more networks (e.g., LANs, WANs, virtual private networks (VPNs), or the like) that interconnect passive authentication computing platform 110, internal entity computing system 120, self-service kiosk 140 and/or self-service kiosk 145 and one or more other computing devices and/or computer systems that are used by, operated by, and/or otherwise associated with the organization.

Referring to FIG. 1B, passive authentication computing platform 110 may include one or more processors 111, memory 112, and communication interface 113. A data bus may interconnect processor(s) 111, memory 112, and communication interface 113. Communication interface 113 may be a network interface configured to support communication between passive authentication computing platform 110 and one or more networks (e.g., network 190, network 195, or the like). Memory 112 may include one or more program modules having instructions that when executed by processor(s) 111 cause passive authentication computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of passive authentication computing platform 110 and/or by different computing devices that may form and/or otherwise make up passive authentication computing platform 110.

For example, memory 112 may have, store and/or include registration data module 112a. Registration data module 112a may store instructions and/or data that may cause or enable the passive authentication computing platform 110 to receive registration data from a plurality of users, and the like. The registration data may include biometric data of each user (e.g., facial images, fingerprint data, retinal scans, or the like). The registration data may be stored in a database, such as database 112e, and retrieved as needed for comparison to received biometric data. In some examples, registration data may further include identification of one or more user accounts associated with the user, and the like.

Passive authentication computing platform 110 may further have, store, and/or include biometric data analysis module 112b. Biometric data analysis module 112b may store instructions and/or data that may cause or enable the passive authentication computing platform 110 to receive biometric data from one or more biometric data capture devices associated with each self-service kiosk 140, 145 (e.g., web camera, keyboard or keypad with integrated fingerprint scanner in one or more keys, touch screen with integrated fingerprint scanner in at least a portion of the touch screen, and the like). The biometric data may be captured continuously as the user interacts with the self-service kiosk 140, 145, on a periodic basis and/or on an aperiodic basis, and may be transmitted to the passive authentication computing platform 110 for analysis. Biometric data analysis module 112b may compare the received biometric data to stored biometric data captured during a registration process. If the data matches, additional biometric data may be received and analyzed. If the data does not match, one or more mitigation actions may be identified.

Passive authentication computing platform 110 may further have, store and/or include mitigation action module 112c. Mitigation action module 112c may store instructions and/or data that may cause or enable the passive authentication computing platform 110 to identify one or more mitigation actions in response to a mismatch of received biometric data and stored biometric data. For instance, a request for additional authentication data may be identified, a lock out of a user from a self-service kiosk may be identified, modification of access or functionality to one or more self-service kiosk functions and/or one or more systems, and the like. Mitigation action module 112c may generate one or more instructions or commands to execute the mitigation actions that may be sent to an impacted self-service kiosk 140, 145, internal entity computing system 120 or the like, for execution.

Passive authentication computing platform 110 may further have, store and/or include notification module 112d. Notification module 112d may store instructions and/or data that may cause or enable passive authentication computing platform 110 to generate one or more notifications based on, for instance, identified mitigation actions. For instance, if a user is locked out of a self-service kiosk 140, 145 in response to a mismatch of biometric data, a notification may be generated and transmitted for display on self-service kiosk 140 and/or self-service kiosk 145 indicating the machine is locked. In some examples, the user may be prompted to re-authenticate or re-initiate a transaction, wait a predetermined time before requesting another transaction, have limited or reduced functionality at the self-service kiosk, or the like. In another example, notification module 112d may generate a notification requesting additional authentication data from a user in response to a detected mismatch of data. Various other notifications may be generated without departing from the invention.

Passive authentication computing platform 110 may further have, store and/or include a database 112e. Database 112e may store biometric data associated with a plurality of users, registration data of user, and the like.

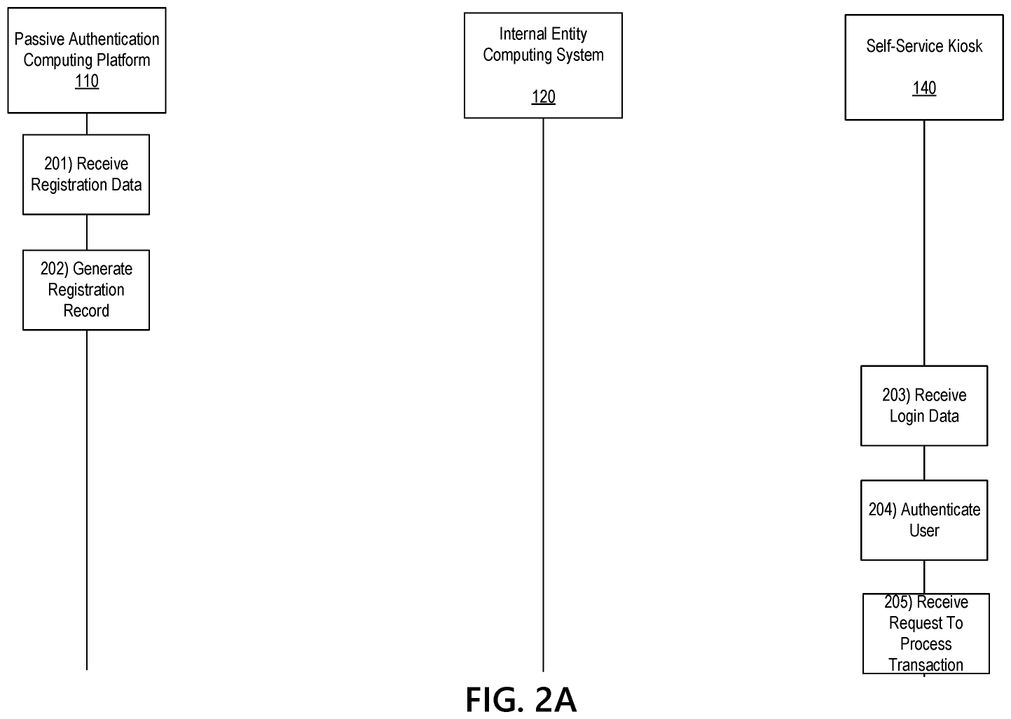

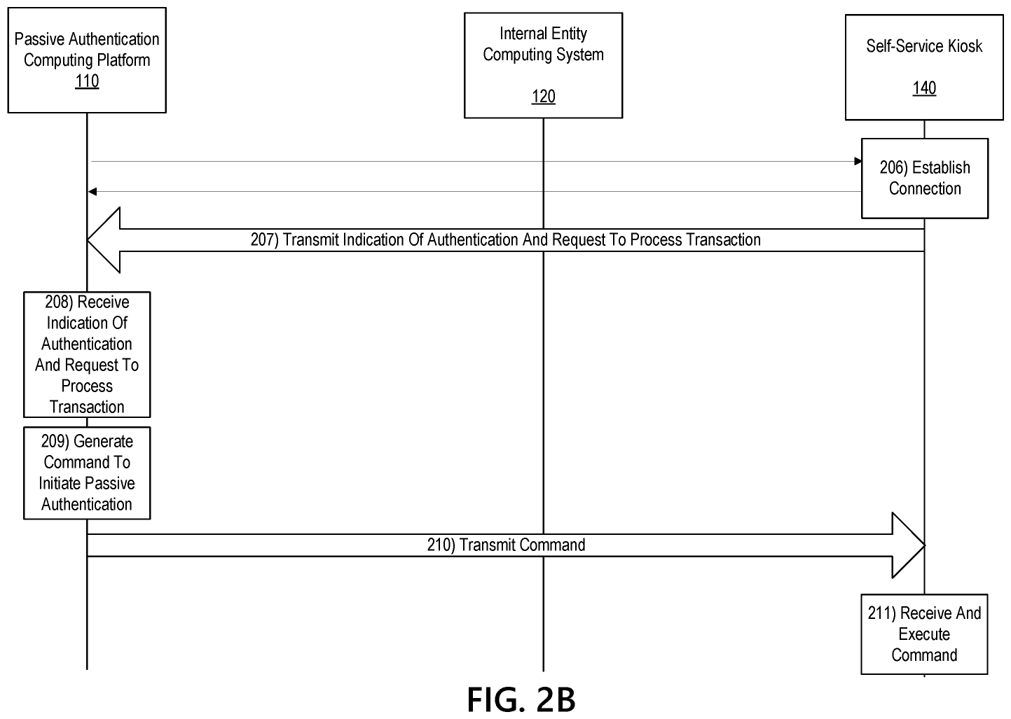

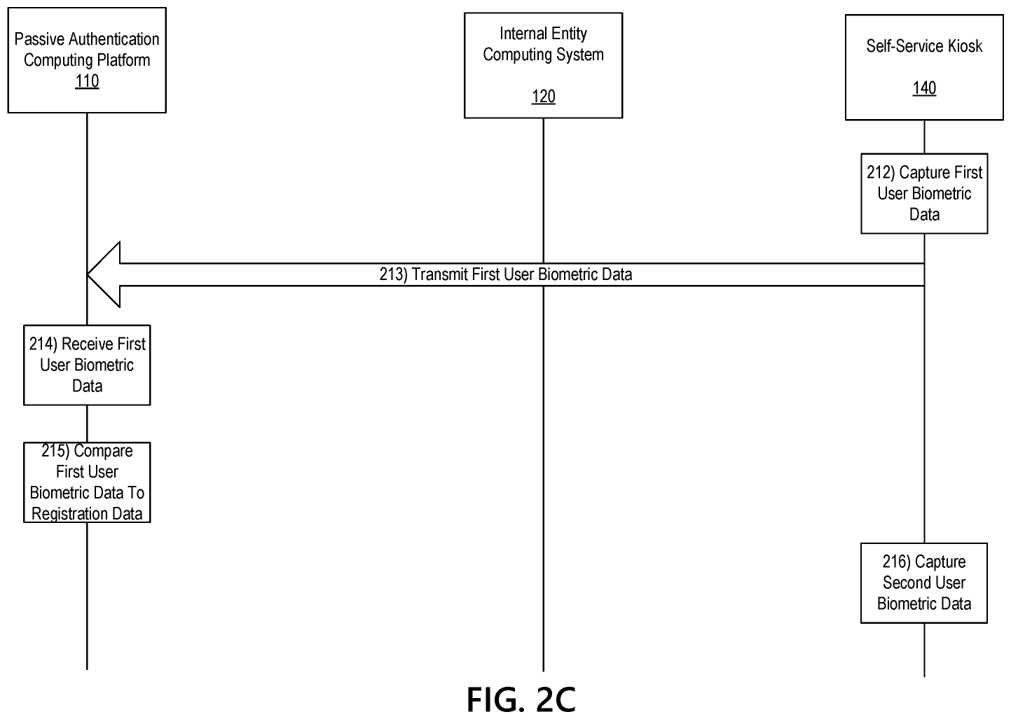

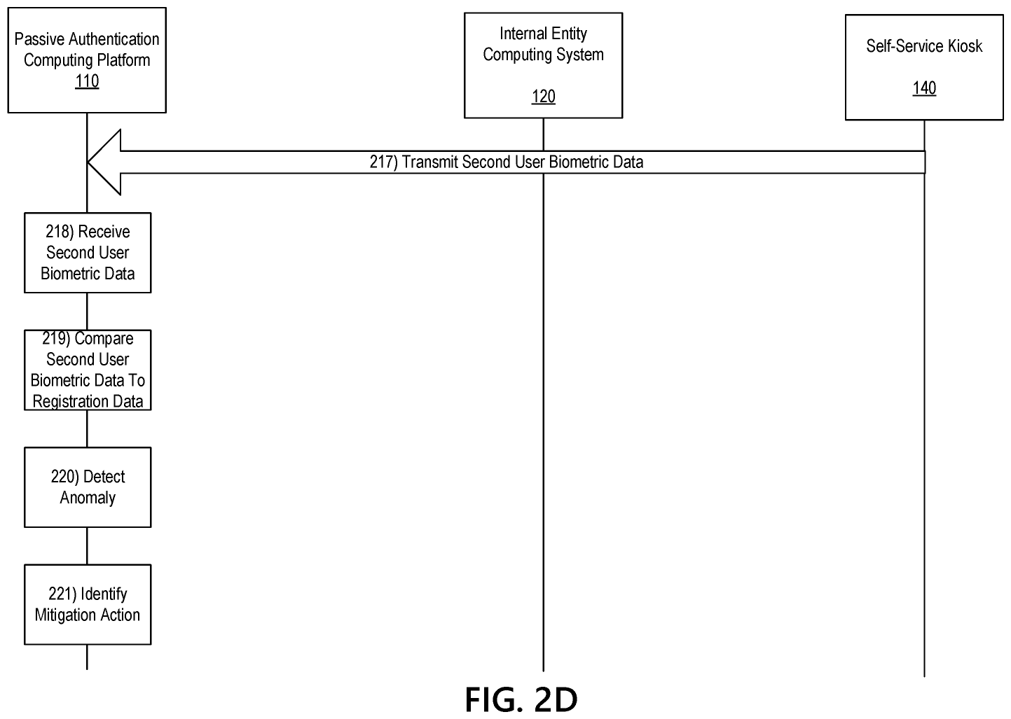

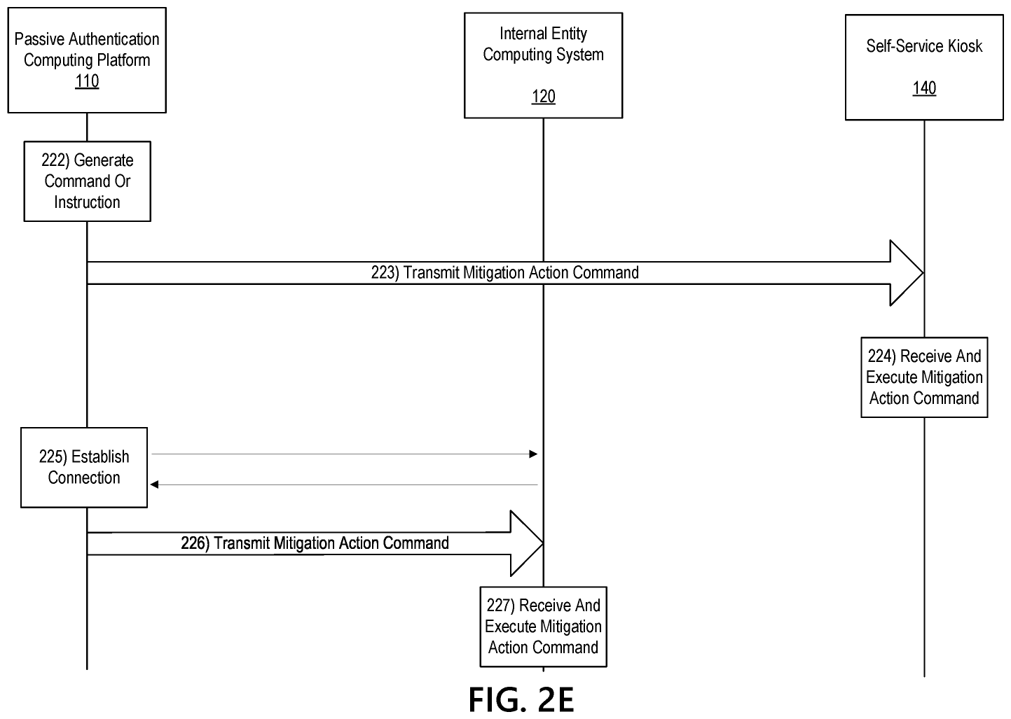

FIGS. 2A-2E depict one example illustrative event sequence for implementing passive authentication functions at a self-service kiosk in accordance with one or more aspects described herein. The events shown in the illustrative event sequence are merely one example sequence and additional events may be added, or events may be omitted, without departing from the invention. Further, one or more processes discussed with respect to FIGS. 2A-2E may be performed in real-time or near real-time.

With reference to FIG. 2A, at step 201, passive authentication computing platform 110 may receive registration data. For instance, passive authentication computing platform 110 may receive registration data from a plurality of users, and the like. In some examples, the registration data may be received from users who are customers of the enterprise organization implementing the passive authentication computing platform 110 and/or users who are not customers or not current customers (e.g., non-customer users of self-service kiosks within a network of the enterprise organization). The registration data may include biometric data of each user (e.g., facial image, fingerprint, retinal scan, or the like), account information of the user, and the like.

In some examples, the registration data may include additional information such as customer permissions to capture biometric data and opt in to the systems/arrangements, identification of additional authorized users and associated biometric data received with those users' permission, customization options for authenticating a user (e.g., multi-factor authentication, multi-factor authentication that relies on card and biometrics rather than card and PIN, or the like), contact information of the user (e.g., phone number, email address or the like), preferred method of contact, and the like.

At step 202, the registration data may be stored and a registration record may be generated. For instance, a database may be modified to include entries for each user for which registration data was received, and the like.

At step 203, login or authentication data may be received by self-service kiosk 140. For instance, a user may initiate a transaction by scanning a card, initiating a transaction via a mobile computing device of the user, or the like. In response to initiating the transaction, the user may provide additional authentication information such as a password, personal identification number (PIN), biometric data, and the like. In response to receiving the login or authentication data, the user may be authenticated at step 204. For instance, the login or authentication data may be compared to pre-stored data associated with a user and, if the data matches, the user may be authenticated and granted access to self-service kiosk 140.

At step 205, self-service kiosk 140 may receive a request to process the transaction. For instance, a user may provide user input selecting a type of transaction to perform (e.g., withdrawal, deposit, balance inquiry, or the like).

With reference to FIG. 2B, at step 206, self-service kiosk 140 may connect to passive authentication computing platform 110. For instance, a first wireless connection may be established between self-service kiosk 140 and passive authentication computing platform 110. Upon establishing the first wireless connection, a communication session may be initiated between self-service kiosk 140 and passive authentication computing platform 110.

At step 207, self-service kiosk 140 may transmit or send an indication of user authentication and request to process transaction to the passive authentication computing platform 110. For instance, the self-service kiosk 140 may transmit or send an indication that the user was authenticated and an indication of the requested transaction to the passive authentication computing platform 110 during the communication session initiated upon establishing the first wireless connection.

At step 208, passive authentication computing platform 110 may receive the indication of authentication and request to process the transaction.

In response to receiving the indication of authentication and request to process the transaction, passive authentication computing platform 110 may, at step 209, generate a command or instruction to initiate passive authentication functions. For instance, a command or instruction that, when executed by the self-service kiosk 140, may cause the self-service kiosk to enable or activate one or more biometric data capture devices, capture biometric data, and the like, may be generated.

Although the arrangements described herein include generating the command or instruction in response to receiving the indication of authentication and request for transaction processing, in some examples, the command or instruction may be generated in response to receiving the indication of authentication and the request to process the transaction may be received, for instance, after the command or instruction to initiate passive authentication has been generated, transmitted, executed or the like.

At step 210, passive authentication computing platform 110 may transmit or send the generated command or instruction to the self-service kiosk 140. In some examples, transmitting or sending the instruction or command may cause the instruction or command to be automatically executed by the self-service kiosk 140.

At step 211, self-service kiosk 140 may receive the command or instruction and may execute the instruction or command. In some examples, executing the instruction or command may cause one or more biometric data collection devices to be activated or enabled. For instance, a camera may be activated, enabled or powered on, one or more integrated fingerprint scanners in a keypad, keyboard or touch screen may be activated or enabled, or the like.

With reference to FIG. 2C, at step 212, self-service kiosk 140 may capture first biometric data. For instance, one or more of the biometric data capture devices may capture biometric data (e.g., facial image, fingerprint, retinal scan, or the like) of a user using self-service kiosk 140 and the first biometric data may be received by the self-service kiosk 140. In some examples, the first biometric data may be captured at a first time. In some examples, the first biometric data may be captured when a user inputs a PIN during the authentication process. That data may then be used for an initial comparison after the user is authenticated and/or passive authentication functions are initiated.

At step 213, the self-service kiosk 140 may transmit or send the first biometric data to the passive authentication computing platform 110.

At step 214, passive authentication computing platform 110 may receive the first biometric data and may process and/or analyze the data.

At step 215, the first biometric data may be compared to the biometric data received at registration for an identified user. For instance, the first biometric data may be compared to a corresponding type of biometric data received during the registration process (e.g., fingerprint compared to fingerprint, and the like) and retrieved from database 112e (e.g., based on user identifying data received in the indication of user authentication). In some examples, the first biometric data may include more than one type of biometric data.

If, at step 215, the first biometric data matches the biometric data received at registration, the process may continue at step 216. If the first biometric data does not match the biometric data received at registration, the process may continue at step 220.

At step 216, second biometric data of the user may be captured. For instance, one or more types of biometric data of the user may be captured via the one or more biometric data capture devices of the self-service kiosk at a second time after or subsequent to the first time. In some examples, biometric data may be continuously captured and transmitted for analysis. Additionally or alternatively, biometric data may be captured at periodic or aperiodic intervals.

With reference to FIG. 2D, at step 217, the self-service kiosk 140 may transmit or send the second biometric data to the passive authentication computing platform 110 for analysis.

At step 218, passive authentication computing platform 110 may receive the second biometric data and process and/or analyze the second biometric data.

At step 219, passive authentication computing platform 110 may compare the second biometric data to the registration data to determine whether a match occurs. If a match occurs, the process may continue to capture and receive biometric data for analysis. If a match does not occur, at step 220, an anomaly may be detected (e.g., mismatch between one or more types of received biometric data and biometric data received at registration).

In response to detecting an anomaly, at step 221, one or more mitigation actions may be identified. For instance, mitigation actions such as a request for additional authentication information, a lockout of a user from the self-service kiosk 140, initiation or activation of additional biometric data capture devices to perform additional passive authentication, modification of functionality of the self-service kiosk, modification of account access via an internal entity computing system 120, disabling of the card that initiated the transaction, pausing or stopping the transaction, and the like may be identified.

In some examples, mitigation actions may include initiating contact with an expected or authorized user via one or more pre-registered devices or channels. For instance, if received biometric data does not match registration biometric data, a mitigation action identified may include pausing the transaction and sending a one-time passcode to a user via a pre-registered device (e.g., via SMS), pre-registered email address, or the like. The user may then be requested to input the OTP into the self-service kiosk to continue the transaction.

Additionally or alternatively, a mitigation action may include pausing the transaction and contacting the user via SMS, telephone, email, or the like, to request confirmation or authorization of the transaction. The user may then accept the call and respond, respond via SMS or email, or the like. In some examples, if the user does not answer the call or respond within a predetermined time period, the transaction may be cancelled.

With reference to FIG. 2E, at step 222, a command or instruction to execute the identified one or more mitigation actions may be generated by the passive authentication computing platform 110. For instance, a command or instructions that, when received by the self-service kiosk 140, may be automatically executed to cause implementation of the one or more mitigation actions may be generated.

At step 223, the passive authentication computing platform 110 may transmit or send the generated mitigation action or command to the self-service kiosk 140. At step 224, the self-service kiosk 140 may receive and execute the mitigation action command or instructions. For instance, in some examples, transmitting or sending the command or instruction may cause the self-service kiosk 140 to automatically execute the command or instruction, thereby implementing or executing the one or more mitigation actions.

In some examples, the one or more mitigation actions may include modifying access to or functionality of other enterprise organization systems. For instance, the one or more mitigation actions may include modifying access to user accounts (e.g., to avoid unauthorized actors withdrawing funds, or the like). In some examples, the account may be controlled or otherwise managed by systems or application executing on systems such as internal entity computing system 120. Accordingly, in those examples, at step 225, passive authentication computing platform 110 may connect to internal entity computing system 120. For instance, a second wireless connection may be established between passive authentication computing platform 110 and internal entity computing system 120. Upon establishing the second wireless connection, a communication session may be initiated between passive authentication computing platform 110 and internal entity computing system 120.

At step 226, the one or more mitigation action commands or instructions may be transmitted or sent to the internal entity computing system 120. For instance, the instruction or command may be transmitted or sent during the communication session initiated upon establishing the second wireless connection.

At step 227, the internal entity computing system 120 may receive and execute the command or instruction. For instance, transmitting or sending the instruction or command may cause the internal entity computing system 120 to automatically execute the instruction or command, thereby implementing the one or more mitigation actions.

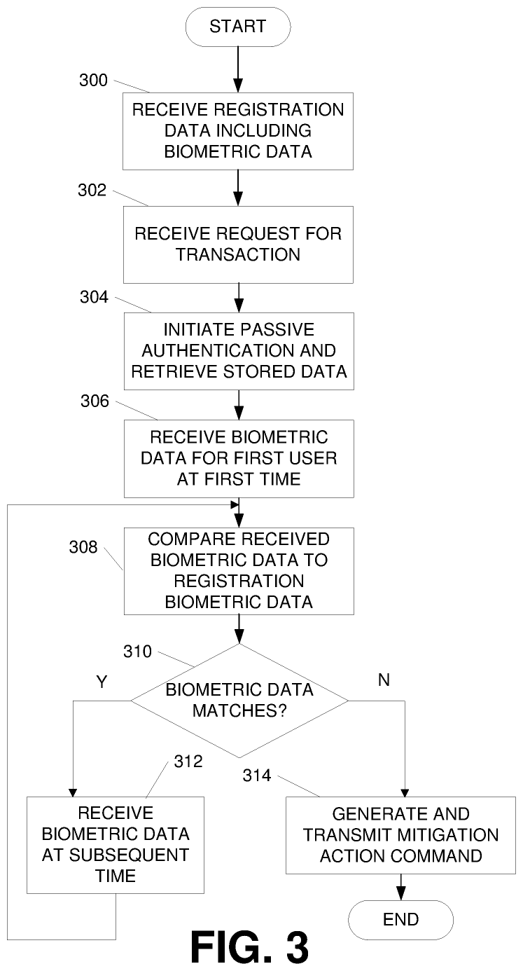

FIG. 3 is a flow chart illustrating one example method of implementing passive authentication functions in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, registration data for a plurality of users may be received. For instance, registration data for a plurality of users (e.g., customers, non-customer users, or the like) of self-service kiosks 140, 145 associated with an enterprise organization may be received by passive authentication computing platform 110. The registration data may include biometric data of each user of the plurality of users (e.g., facial images, retinal scans, fingerprints, and the like) captured with permission of the user. The registration data may further include user identifying information (e.g., name, contact information, and the like), user account information, and the like.

At step 302, an indication of a user authentication and request for transaction processing at a self-service kiosk 140 by a first user may be received. For instance, a first user may initiate a transaction at the self-service kiosk 140 by scanning, swiping, or the like, a card (e.g., debit card, credit card, or the like) and entering authentication data (e.g., username and password, PIN, or the like). In response to the self-service kiosk authenticating the user, the user may request a particular transaction (e.g., from a plurality of selectable options displayed by a display of the self-service kiosk.

In response to receiving the transaction processing request and indication of authentication, at step 304, passive authentication functions may be initiated. For instance, a command or instruction causing activation or initiation of one or more biometric data collection devices may be generated and transmitted to the self-service kiosk 140. For instance, an instruction or command causing a camera to activate and capture image data of the user as the user is interacting with the self-service kiosk, causing a keypad with integrated fingerprint scanners in one or more keys to be enabled or activated, causing a touch screen with an integrated fingerprint scanner to be activated, or the like, may be generated and transmitted to the self-service kiosk 140. Transmitting the command or instruction to the self-service kiosk 140 may cause the self-service kiosk 140 to automatically execute the command or instruction.

In some examples, receiving the transaction processing request and indication of login may further cause the passive authentication computing platform 110 to retrieve stored biometric data associated with the user. For instance, based on the indication of authentication, user identifying information (e.g., provided during authentication) may be used to retrieve pre-stored biometric data provided at registration.

At step 306, biometric data captured at a first time by the activated one or more biometric data collection devices of the self-service kiosk 140 may be received by the passive authentication computing platform 110. For instance, an image of a user captured by a camera, a fingerprint from a keyboard, or the like, may be received by the passive authentication computing platform 110.

At step 308, the received biometric data captured at the first time may be compared to the biometric data associated with the first user and received with the registration data (e.g., and retrieved in response to the authentication of the user and request for transaction processing) to determine whether the received biometric data matches the biometric data associated with the first user and received with the registration data.

At step 310, if the received biometric data matches the registration biometric data of the first user, the process may proceed to step 312 where additional biometric data may be captured at a second or subsequent time. For instance, the system may continue to passively capture (e.g., without user input or action outside of normal or expected function in interacting with the self-service kiosk) biometric authentication data at additional times (e.g., continuously, periodically, aperiodically, or the like). The process may then return to step 308 where the subsequently received biometric data may be compared to registration data to again authenticate the user (e.g., confirm a same user is still using or operating the self-service kiosk 140).

If, at step 310, the received biometric data does not match the registration biometric data of the first user, one or more mitigation actions may be identified and one or more commands or instructions to execute the one or more mitigation actions may be generated and transmitted to the self-service kiosk 140 for execution. For instance, mitigations actions such as a request for additional authentication data from the user, a command to lock the first user out of the self-service kiosk 140, an instruction to passively capture additional types of biometric data, and instruction modifying functionality of the self-service kiosk, or the like may be identified, transmitted to the self-service kiosk 140 and executed by the self-service kiosk 140.

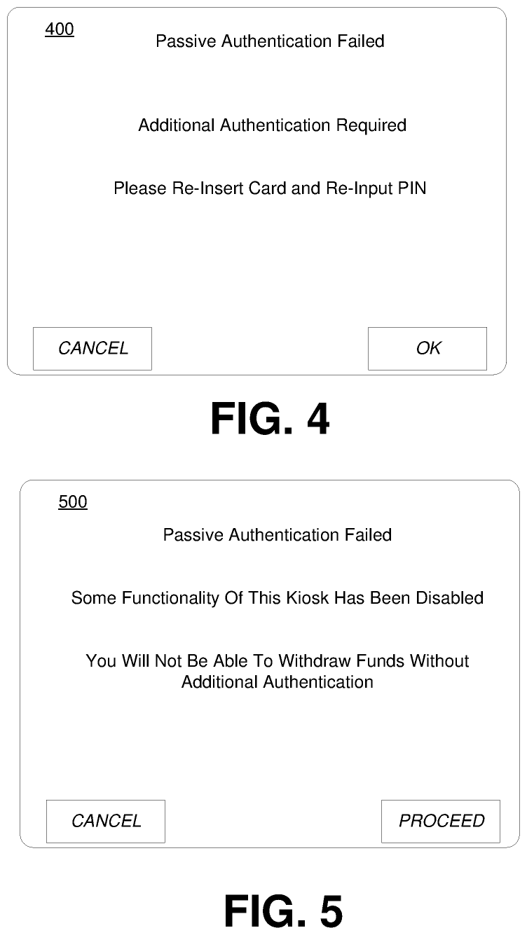

FIG. 4 illustrates one example user interface 400 that may be displayed by a display of self-service kiosk 140 in response to failure to match received biometric data to registration biometric data in accordance with one or more aspects described herein. The user interface 400 includes a request for the user to input authentication credentials (e.g., the user may be locked out of the self-service kiosk 140 and may have to re-scan a card, re-input a PIN, or the like to regain access to the self-service kiosk 140).

FIG. 5 illustrates another example user interface 500 that may be displayed by a display of self-service kiosk 140 in response to failure to match received biometric data to registration data in accordance with one or more aspects described herein. The user interface 500 may indicate that passive authentication failed and that functionality of the self-service kiosk 140 has been modified in response. For instance, the self-service kiosk might not permit withdrawals without additional authentication data. The user may then select to proceed with the initiated transaction or cancel.

As discussed herein, aspects described are directed to passive authentication of users to ensure that a user who initiated a transaction at a self-service kiosk or an in-person transaction continues to interact with the device through the transaction process. As discussed, by passively capturing biometric data throughout the user interaction (e.g., on a continuous basis, periodic basis, aperiodic basis, or the like), the system may ensure that authorized users or expected users are accessing the self-service kiosk, particular accounts, and the like.

While aspects described herein are discussed in the context of a self-service kiosk such as an ATM or ATA, aspects described may be used with in-person transactions, such as at a banking branch or location. For instance, if an unauthorized user enters a banking location with an authorized user's information (e.g., PIN, or the like), the unauthorized user may be able to initiate the transaction but completion of the transaction might be stopped based on biometric data captured via one or more input screens, keypads, keyboards, or the like. Accordingly, unauthorized activity may be proactively identified and mitigation actions quickly initiated to limit impact to the user.

As discussed, the biometric data of the user may be captured and analyzed on a continuous basis (e.g., facial image of user may be continuously captured by camera or other image capture device and compared to image data received at registration, fingerprint data may be captured from a plurality of keystrokes or each keystroke and compared to fingerprint data received at registration, and the like). Additionally or alternatively, biometric data may be captured on a periodic basis (e.g., every 10 seconds, 5 seconds, or the like) to conserve computing power and resources in situations where that is a goal. Further, in some examples, the biometric data may be captured on an aperiodic basis (e.g., after 10 seconds then again after 5 seconds then again after another 2 seconds, or the like). Capturing data on an aperiodic basis may avoid unauthorized actors predicting when the biometric data may be captured.

In some examples, more than one or all types of biometric data may be captured and analyzed to passively authenticate the user. In some arrangements, one type of biometric data may be captured and analyzed and, if an issue arises (e.g., captured biometric data does not match registration biometric data) capture of additional type(s) of biometric data may be initiated. For instance, if facial image data is captured to passively authenticate the user and, at some point, a captured image does not match the registration data, fingerprint capture may be initiated to confirm whether an issue has occurred. Accordingly, this may aid in reducing or eliminating identification of false positives.

As discussed herein, if received biometric data does not match registration biometric data for a particular user, one or more mitigation actions may be identified and executed. For instance, the user may be locked out of the self-service kiosk and/or may be required to again input authentication credentials. In some examples, a time out period may be used and the user may be required to wait a predetermined time (e.g., 5 minutes, 10 minutes, 30 minutes, or the like) before authentication credentials can be input to re-authenticate.

In some examples, two failures of passive authentication may be required before the user is locked out of the machine. For instance, if a first type of biometric data does not match, a second type may be captured and analyzed. If the second type also does not match, a lock out may be executed.

In some examples, a one-time passcode (OTP) may be transmitted to a registered user device (e.g., mobile device of the user) and may be used to confirm authentication of the user as a mitigation action. The user may provide a phone number, email address, or other device identifier during registration and the OTP may be sent to the phone number or email address. The user may then be requested to input the OTP into a generated user interface displayed on the self-service kiosk in order to continue the transaction.

In some examples, users may select to have one or more additional users added to the registration record for the user. For instance, a user may select to have one or more additional users (e.g., who provide biometric data with permission) added to a biometric profile. Accordingly, if an authorized user gives their card and PIN to another authorized user, the computing platform 110 may identify that, while the biometric data captured by the self-service kiosk is not the data of the expected user, it does/does not match one of the additional users and may proceed with either capturing additional data or initiating mitigation actions based on the comparing.

In some examples, users may (e.g., during registration) elect one or more options for initiating a transaction at a self-service kiosk 140. For instance, a user may select to swipe or scan a card and have a facial image captured. Those two forms of authentication may then be compared to pre-stored data and, if a match occurs, the transaction may be initiated. Various other forms of authentication (e.g., fingerprint and card, facial image and fingerprint, or the like) may be used without departing from the invention.

As discussed, the arrangements described herein may reduce or eliminate the impact of unauthorized users gaining access to an authorized users authentication data (e.g., card and PIN, or the like) by relying on biometric data captured as the user interacts with the self-service kiosk to continuously or near-continuously authenticate the user.

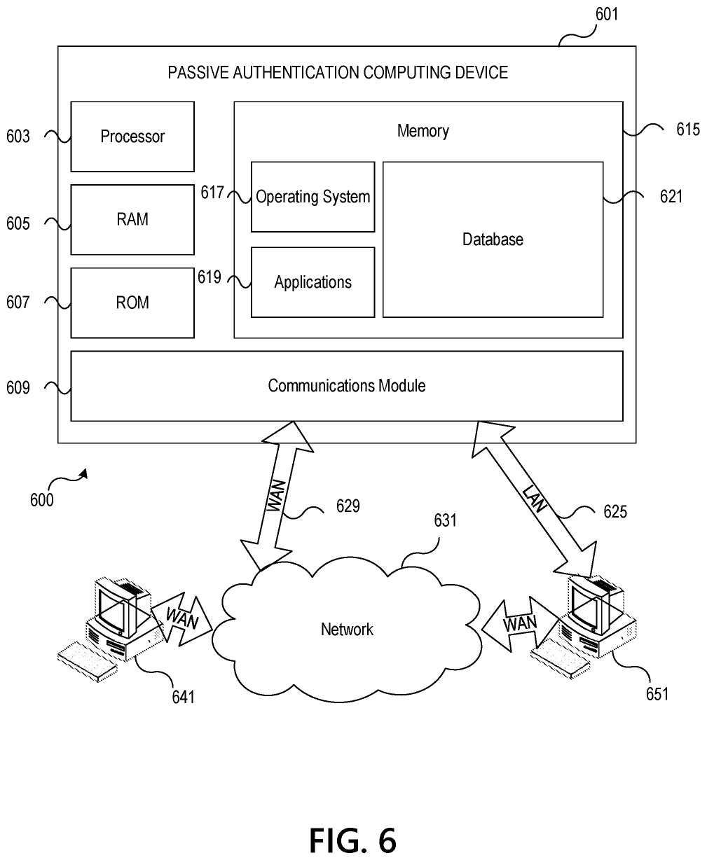

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include passive authentication computing device 601 having processor 603 for controlling overall operation of passive authentication computing device 601 and its associated components, including Random Access Memory (RAM) 605, Read-Only Memory (ROM) 607, communications module 609, and memory 615. Passive authentication computing device 601 may include a variety of computer readable media. Computer readable media may be any available media that may be accessed by passive authentication computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by passive authentication computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on passive authentication computing device 601. Such a processor may execute computer-executable instructions stored on a computer-readable medium.

Software may be stored within memory 615 and/or storage to provide instructions to processor 603 for enabling passive authentication computing device 601 to perform various functions as discussed herein. For example, memory 615 may store software used by passive authentication computing device 601, such as operating system 617, application programs 619, and associated database 621. Also, some or all of the computer executable instructions for passive authentication computing device 601 may be embodied in hardware or firmware. Although not shown, RAM 605 may include one or more applications representing the application data stored in RAM 605 while passive authentication computing device 601 is on and corresponding software applications (e.g., software tasks) are running on passive authentication computing device 601.

Communications module 609 may include a microphone, keypad, touch screen, and/or stylus through which a user of passive authentication computing device 601 may provide input, and may also include one or more of a speaker for providing audio output and a video display device for providing textual, audiovisual and/or graphical output. Computing system environment 600 may also include optical scanners (not shown).

Passive authentication computing device 601 may operate in a networked environment supporting connections to one or more remote computing devices, such as computing device 641 and 651. Computing devices 641 and 651 may be personal computing devices or servers that include any or all of the elements described above relative to passive authentication computing device 601.

The network connections depicted in FIG. 6 may include Local Area Network (LAN) 625 and Wide Area Network (WAN) 629, as well as other networks. When used in a LAN networking environment, passive authentication computing device 601 may be connected to LAN 625 through a network interface or adapter in communications module 609. When used in a WAN networking environment, passive authentication computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive registration data for a plurality of users, the registration data including biometric data of each user of the plurality of users, wherein the plurality of users includes at least a first user;
receive, from a self-service kiosk, a request to process a transaction for the first user, the request to process the transaction including an indication of authentication of the first user;
initiate, in response to the request to process the transaction, passive biometric authentication processes, wherein the passive biometric authentication processes include activating one or more biometric data capture devices associated with the self-service kiosk;
receive, from the one or more biometric data capture devices, first biometric data of the first user captured at a first time;
compare the received first biometric data of the first user captured at the first time to the biometric data of the registration data associated with the first user;
responsive to determining that the received first biometric data matches the biometric data of the registration data associated with the first user, receive, from the one or more biometric data capture devices, additional biometric data of the first user captured at a second time subsequent to the first time; and
responsive to determining that the received first biometric data does not match the biometric data of the registration data associated with the first user, transmit a mitigation command to the self-service kiosk, wherein transmitting the mitigation command to the self-service kiosk causes the self-service kiosk to execute the mitigation command.

2. The computing platform of claim 1, wherein at least one biometric data capture device is integrated with a user input device of the self-service kiosk.

3. The computing platform of claim 2, wherein the user input device is one of: a keypad of the self-service kiosk or a touch screen of the self-service kiosk.

4. The computing platform of claim 3, wherein the one of: the keypad of the self-service kiosk or the touch screen of the self-service kiosk includes an integrated fingerprint scanner.

5. The computing platform of claim 4, wherein the user input device is the touch screen of the self-service kiosk and the integrated fingerprint scanner is integrated into an entirety of the touch screen of the self-service kiosk.

6. The computing platform of claim 4, wherein the user input device is the keypad and the integrated fingerprint scanner is integrated into each key of the keypad.

7. The computing platform of claim 1, wherein the first biometric data includes at least one of: a facial image, a retinal scan and a fingerprint.

8. The computing platform of claim 1, wherein the one or more biometric data capture devices include a camera.

9. The computing platform of claim 1, wherein the mitigation command includes a command to modify a functionality of the self-service kiosk.

10. A method, comprising:
receiving, by a computing platform, the computing platform having at least one processor and memory, registration data for a plurality of users, the registration data including biometric data of each user of the plurality of users, wherein the plurality of users includes at least a first user;
receiving, by the at least one processor and from a self-service kiosk, a request to process a transaction for the first user, the request to process the transaction including an indication of authentication of the first user;
initiating, by the at least one processor and in response to the request to process the transaction, passive biometric authentication processes, wherein the passive biometric authentication processes include activating one or more biometric data capture devices associated with the self-service kiosk;
receiving, by the at least one processor and from the one or more biometric data capture devices, first biometric data of the first user captured at a first time;
comparing, by the at least one processor, the received first biometric data of the first user captured at the first time to the biometric data of the registration data associated with the first user;
responsive to determining that the received first biometric data matches the biometric data of the registration data associated with the first user, receiving, by the at least one processor and from the one or more biometric data capture devices, additional biometric data of the first user captured at a second time subsequent to the first time; and
responsive to determining that the received first biometric data does not match the biometric data of the registration data associated with the first user, transmitting, by the at least one processor, a mitigation command to the self-service kiosk, wherein transmitting the mitigation command to the self-service kiosk causes the self-service kiosk to execute the mitigation command.

11. The method of claim 10, wherein at least one biometric data capture device is integrated with a user input device of the self-service kiosk.

12. The method of claim 11, wherein the user input device is one of: a keypad of the self-service kiosk or a touch screen of the self-service kiosk.

13. The method of claim 12, wherein the one of: the keypad of the self-service kiosk or the touch screen of the self-service kiosk includes an integrated fingerprint scanner.

14. The method of claim 13, wherein the user input device is the touch screen of the self-service kiosk and the integrated fingerprint scanner is integrated into an entirety of the touch screen of the self-service kiosk.

15. The method of claim 13, wherein the user input device is the keypad and the integrated fingerprint scanner is integrated into each key of the keypad.

16. The method of claim 10, wherein the first biometric data includes at least one of: a facial image, a retinal scan and a fingerprint.

17. The method of claim 10, wherein the one or more biometric data capture devices include a camera.

18. The method of claim 10, wherein the mitigation command includes a command to modify a functionality of the self-service kiosk.

19. One or more non-transitory computer-readable media storing instructions that, when executed by a computing platform comprising at least one processor, memory, and a communication interface, cause the computing platform to:
receive registration data for a plurality of users, the registration data including biometric data of each user of the plurality of users, wherein the plurality of users includes at least a first user;
receive, from a self-service kiosk, a request to process a transaction for the first user, the request to process the transaction including an indication of authentication of the first user;
initiate, in response to the request to process the transaction, passive biometric authentication processes, wherein the passive biometric authentication processes include activating one or more biometric data capture devices associated with the self-service kiosk;
receive, from the one or more biometric data capture devices, first biometric data of the first user captured at a first time;
compare the received first biometric data of the first user captured at the first time to the biometric data of the registration data associated with the first user;
responsive to determining that the received first biometric data matches the biometric data of the registration data associated with the first user, receive, from the one or more biometric data capture devices, additional biometric data of the first user captured at a second time subsequent to the first time; and
responsive to determining that the received first biometric data does not match the biometric data of the registration data associated with the first user, transmit a mitigation command to the self-service kiosk, wherein transmitting the mitigation command to the self-service kiosk causes the self-service kiosk to execute the mitigation command.

20. The one or more non-transitory computer-readable media of claim 19, wherein at least one biometric data capture device is integrated with a user input device of the self-service kiosk.
